(19) United States
(12) Patent Application Publication
(10) Pub. No.: US 2009/0059186 A1
(43) Pub. Date: Mar. 5, 2009

(54) LAMP HOLDER OF A PROJECTION APPARATUS AND FABRICATION THEREOF

(75) Inventors: Chih-Hao Wu, Hsinchu (TW); Ying-Yuan Shen, Hsinchu (TW); Jung-Chi Chen, Hsinchu (TW); Tsan-Fu Tseng, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsinchu (TW)

(21) Appl. No.: 12/123,518

(22) Filed: May 20, 2008

(30) Foreign Application Priority Data
Aug. 31, 2007 (TW) 96132432

(51) Int. Cl. F21V 33/00

(52) U.S. Cl. 353/119

(57) ABSTRACT

A method for forming a lamp holder. The lamp holder is applied in a projection apparatus. First, the lamp holder comprising metal is provided. An insulating layer is formed on one surface of the lamp holder to insulate the lamp holder from another element of the projection apparatus.

### BACKGROUND OF THE INVENTION

1. Field of the Invention

The invention relates to a projection apparatus, and more particularly relates to a lamp holder and fabrication thereof.

2. Description of the Related Art

In order to present high brightness (high luminous) pictures, a projection apparatus typically uses an ultra high performance lamp as a light source. a voltage of several thousands volts is applied to opposite electrodes in a mercury vapor of an ultra high performance lamp to form an electric arc for lighting. Isolation safety between a wire tip of an ultra high performance lamp and neighboring elements must be a concern for designers to prevent high-voltage flashover or short circuiting at the instant.

Methods for keeping isolation safety between a wire tip and neighboring elements typically include two aspects. In one conventional embodiment, a plastic lamp holder is non-conductive. In the other conventional embodiment, a metal lamp holder which has good rigidity increases distance between a lamp holder and a wire tip.

Both the conventional methods, however, have disadvantages. Because luminance specification of a projection apparatus has continuously increased, and lamp power consumption and working temperature have greatly increased, the lamp holder containing plastic material should have a high heat-resistant coefficient to endure the high temperature. This, however, increases costs and reduces competitive pricing in the projection apparatus market. A projection apparatus is required to be light and small, and inner spacer thereof needs to be optimized. Volume of a projection apparatus is increased when increasing distance between a lamp holder and a wire tip. This is a major limitation for shrinkage of a projection apparatus.

In addition, safe distance between a metal lamp holder and neighboring elements is calculated only in normal conditions. When a lamp works abnormally and explodes, a wire tip may break away from the tip and contact the lamp holder to generate flashover and short circuiting. Consequently, the method for keeping safe distance between the metal lamp holder and neighboring elements is not safe enough. A lamp driver and a low voltage power supply (LVPS) of the projection apparatus may also be damaged when flashover or short circuiting occurs, thus increasing cost of repairs.

### BRIEF SUMMARY OF INVENTION

One embodiment of the invention provides a lamp holder and a method for enhancing isolation of the lamp holder. An embodiment of the invention prevents flashover and short circuiting when a wire tip breaks away from the tip to contact the lamp holder. In the invention, a safe distance is of less concern, thus allowing designs to be more flexible.

In an embodiment of the invention, a method for forming a lamp holder for application in a projection apparatus is disclosed, including forming a lamp holder including metal, and depositing an insulating layer on a surface of the lamp holder to insulate the lamp holder from another element of the projection apparatus.

In another embodiment of the invention, a lamp holder for application in a projection apparatus is disclosed. A lamp holder including metal is provided. An insulating layer is disposed on a surface of the lamp holder, wherein the insulating layer can insulate the lamp holder from another element of the projection apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF DRAWINGS

The invention can be more fully understood by reading the subsequent detailed description and examples with references made to the accompanying drawings, wherein:

FIG. 1A shows a schematic cross section, illustrating an embodiment of a method for forming an isolating layer on a surface of a lamp holder of the invention.

FIG. 1B shows a cross section of an embodiment of a lamp holder of the invention.

FIG. 1C shows a three dimensional view of an embodiment of a lamp holder of the invention.

FIG. 2 shows a cross section of an embodiment of a lamp module of the invention.

FIG. 3 shows a top view of an embodiment of a projection apparatus of the invention.

FIG. 4 shows a schematic cross section, illustrating a wire tip connected to a tip breaking away when an abnormal lamp explodes.

### DETAILED DESCRIPTION OF INVENTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

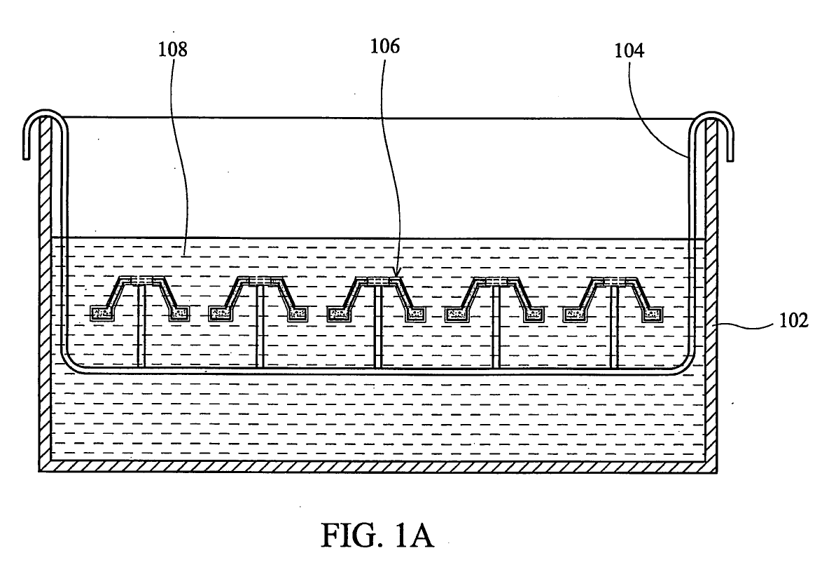

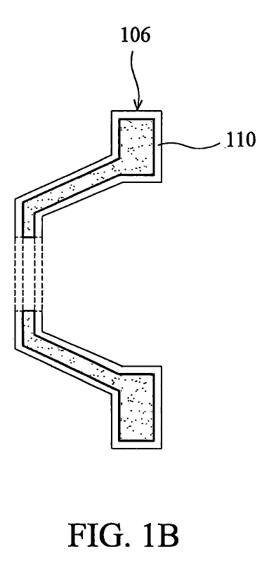

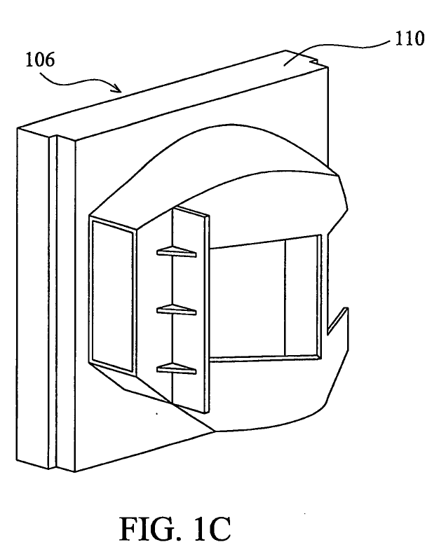

FIG. 1A shows a schematic cross section, illustrating an embodiment of a method for forming an isolating layer on a surface of a lamp holder of the invention. FIG. 1B shows a schematic cross section of an embodiment of the lamp holder 106 of the invention. FIG. 1C shows a three dimensional view of an embodiment of the lamp holder 106 of the invention. Referring to FIG. 1A, before depositing an insulating layer 110 on a surface of a lamp holder 106, a de-oil and a cleaning process (not shown) is performed. Next, the lamp holder 106 formed of metal material is put in an electrolyte 108 of an oxide container 102, wherein the lamp holder 106 is carried by a hanging fixture 104. Positive voltage is applied to the lamp holder 106, acting as an anode, and negative voltage is applied to the electrolyte 108, acting as a cathode. As shown in FIGS. 1B and 1C, an insulating layer 110 is deposited on a surface of the lamp holder 106 by anodic oxidation process.

In an embodiment of the invention, the lamp holder 106 is aluminum, magnesium or magnalium, the insulating layer 110 formed by anodic oxidation process is aluminum oxide, magnesium oxide or magnalium oxide, and the electrolyte 108 is sulfuric acid. In an embodiment of the invention, the sulfuric acid is maintained at a temperature of 3° C.˜6° C., the applied voltage is 16V˜18V, and the concentration of the sulfuric acid is 175 g/L˜185 g/L. The insulating layer 110 preferably has thickness substantially more than 15 μm, and more preferably about 20 μm˜50 μm. After depositing the insulating layer 110 on the surface, the lamp holder 106 can be dyed and sealed (not shown).

Note that the method for forming an insulating layer 110 on the surface of the lamp holder 106 is not limited to the aforementioned anodic oxidation process, but a plasma oxidation process can also be used. A plasma oxidation process of an embodiment of the invention includes applying plasma to a lamp holder including metal, and oxidizing the surface thereof to form an insulating layer. Note that the lamp holder is not limited to that shown in FIGS. 1A˜1C, but other types of lamp holders can also be used.

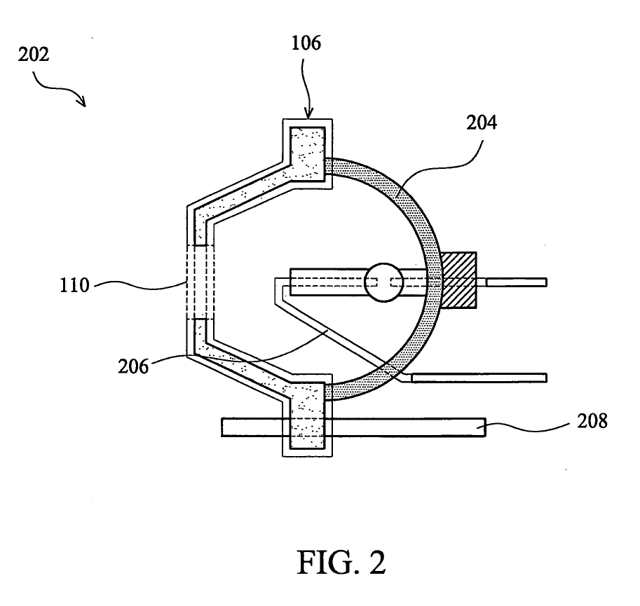

Next, referring to FIG. 2, after the insulating layer 110 is formed on the surface of the lamp holder 106, a lamp 204 and a wire tip 206 can be combined to the lamp holder 106. The lamp holder 106 is then combined to the base 208 to form a lamp module 202 of an embodiment of the invention.

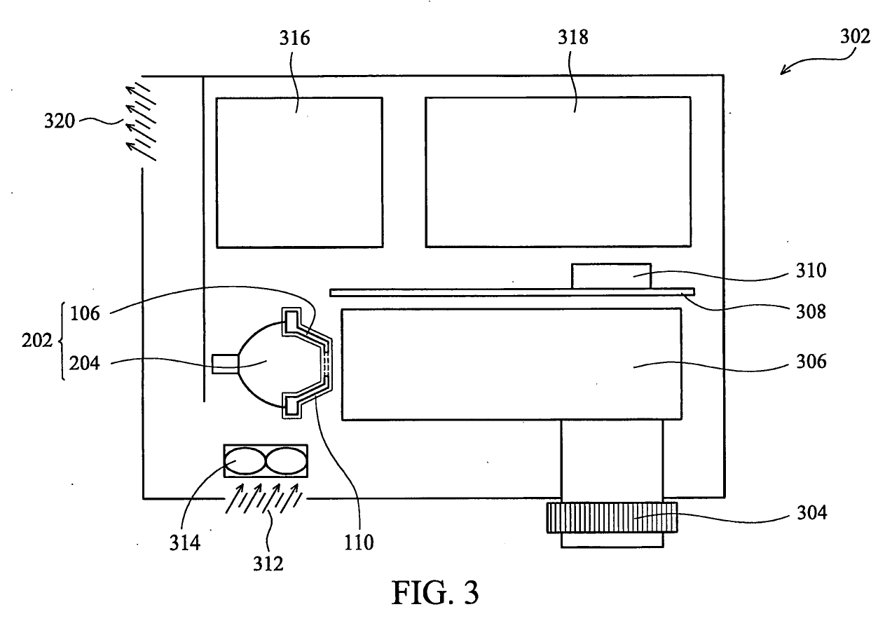

Referring to FIG. 3, a plan view of an embodiment of the invention, the lamp module 202 including the lamp 204 and the lamp holder 106 is disposed in a projection apparatus 302. In an embodiment of the invention, projection apparatus 302 may further include a project lens 304, an optical engine 306, an inverter 308, a light valve 310, a motherboard 318, a power supply 316, a fan 314, an air inlet 312 and/or an air outlet 320. Note that the invention is not limited to the projection apparatus 302 shown in FIG. 3, but the lamp module 202 can also be applied to other types of projection apparatuses. Elements in the projection apparatus can increase or decrease when required.

Because the insulating layer 110 is formed on the surface of the lamp holder 106 according the embodiments described, safe distance between the lamp holder 106 and the wire tip 206 is not critical. Therefore, design of the projection apparatus is more flexible. For example, since safe distance between the lamp holder 106 and the wire tip 206 is not a concern, size of the lamp holder 106 of the lamp module 202 can be reduced, under the condition that a light path is not affected. Furthermore, the lamp holder 106 can be formed of metal of a lower price rather than plastics to reduce overall costs thereof.

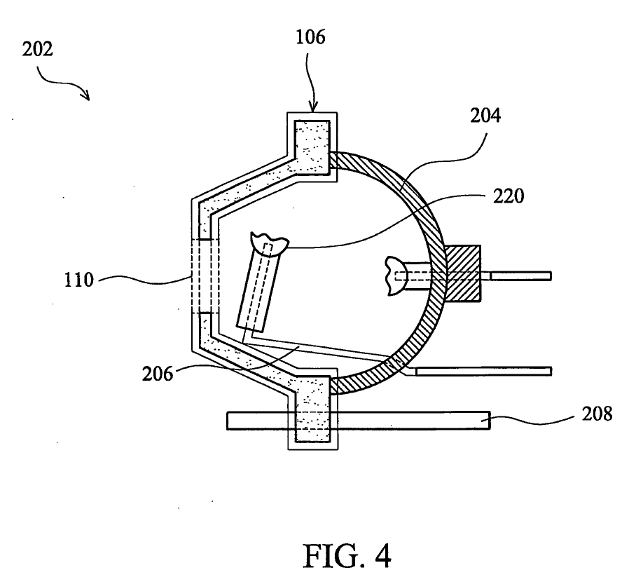

Referring to FIG. 4, when the lamp 204 is abnormal and explodes, the wire tip 206 connected to the tip 220 breaks away, and contacts the lamp holder 106. Because the lamp holder 106 is treated by, for example anodic or plasma treatment for providing isolation, flashover and short circuiting does not occur at this time, and thus the inverter for driving the lamp and the power supply for supplying power to the projection apparatus is not damaged.

In addition, illumination of the projection apparatus continuously increases, and thus generates more heat. The air inlet is required to be closer to a light source to improve cooling efficiency. The projection apparatus of the embodiment of the invention can be designed to have an air inlet as close to the light source as possible, thus increasing design flexibility.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for forming a lamp holder, wherein the lamp holder is applied in a projection apparatus, the method comprising:
forming a lamp holder comprising metal; and
depositing an insulating layer on a surface of the lamp holder to insulate the lamp holder from another element of the projection apparatus.

2. The method as claimed in claim 1, wherein the step of depositing the insulating layer on the surface of the lamp holder is accomplished by an anodic oxidation process.

3. The method as claimed in claim 2, further comprising performing a de-oil process and a cleaning process to the lamp holder before the step of depositing the insulating layer on the surface of the lamp holder.

4. The method as claimed in claim 2, further comprising performing a dying process and a sealing process after the step of depositing the insulating layer on the surface of the lamp holder.

5. The method as claimed in claim 2, wherein the step of depositing the insulating layer on the surface of the lamp holder comprises:
putting the lamp holder in an oxide container containing a sulfuric acid; and
applying voltage to the sulfuric acid and the lamp holder respectively.

6. The method as claimed in claim 5, wherein the sulfuric acid has a concentration of 175 g/L˜185 g/L and is maintained at temperature of 3° C.˜6° C., and the voltage is 16V˜18V.

7. The method as claimed in claim 1, wherein the step of depositing the insulating layer on the surface of the lamp holder is accomplished by a plasma oxidation process.

8. The method as claimed in claim 7, wherein the step of depositing the insulating layer on the surface of the lamp holder comprises:
applying a plasma on the surface of the lamp holder to oxidize of the surface of the lamp holder.

9. The method as claimed in claim 1, wherein the metal is aluminum, magnesium or magnalium.

10. The method as claimed in claim 1, wherein the insulating layer is aluminum oxide, magnesium oxide or magnalium oxide.

11. The method as claimed in claim 1, wherein thickness of the insulating layer is larger than 15 μm.

12. The method as claimed in claim 11, wherein thickness of the insulating layer is 20 μm˜50 μm.

13. The method as claimed in claim 1, wherein the another element is a lamp, and when the lamp explodes, the insulating layer is suitable for preventing short circuiting between the lamp holder and a wire tip of the lamp.

14. A lamp holder, wherein the lamp holder is applied in a projection apparatus, and the lamp holder comprising:
a lamp holder comprising metal; and
an insulating layer on a surface of the lamp holder, wherein the insulating layer insulates the lamp holder from another element of the projection apparatus.

15. The lamp holder as claimed in claim 14, wherein the metal is aluminum, magnesium or magnalium.

16. The lamp holder as claimed in claim 14, wherein the insulating layer is aluminum oxide, magnesium oxide or magnalium oxide.

17. The lamp holder as claimed in claim 14, wherein thickness of the insulating layer is larger than 15 μm.

18. The lamp holder as claimed in claim 17, wherein thickness of the insulating layer is 20 μm˜50 μm.

19. The lamp holder as claimed in claim 14, wherein the another element is a lamp, and when the lamp explodes, the insulating layer is suitable for preventing short circuiting between the lamp holder and a wire tip of the lamp.
